(19) United States
(12) Patent Application Publication
(10) Pub. No.: US 2013/0332987 A1
(43) Pub. Date: Dec. 12, 2013

(54) DATA COLLECTION AND ANALYSIS SYSTEMS AND METHODS

(71) Applicant: Intertrust Technologies Corp., Sunnyvale, CA (US)

(72) Inventors: Sanjeev Tenneti, San Ramon, CA (US); Prasad Khambete, Cupertino, CA (US); William B. Bradley, Oakland, CA (US); Prasad Sanagavarapu, San Jose, CA (US)

(73) Assignee: Intertrust Technologies Corporation, Sunnyvale, CA (US)

(21) Appl. No.: 13/914,538

(22) Filed: Jun. 10, 2013

Related U.S. Application Data
(60) Provisional application No. 61/658,182, filed on Jun. 11, 2012.

(51) Int. Cl. G06F 21/44

(52) U.S. Cl. CPC G06F 21/44
USPC 726/1; 726/4

(57) ABSTRACT

This disclosure relates to systems and methods for the secure management of digital or electronic information relating to a user. In certain embodiments, systems and methods disclosed herein may allow for personal information related to a user to be managed, shared, and/or aggregated between one or more devices used by the user to consume content. In further embodiments, systems and methods disclosed herein may be used to ensure privacy and/or security of user personal information.

### RELATED APPLICATIONS

This application claims the benefit of priority under 35 U.S.C. §119(e) to U.S. Provisional Patent Application No. 61/658,182, filed Jun. 11, 2012, and entitled “DATA COLLECTION AND ANALYSIS SYSTEMS AND METHODS”, which is hereby incorporated by reference in its entirety.

### COPYRIGHT AUTHORIZATION

Portions of the disclosure of this patent document may contain material which is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### BACKGROUND AND SUMMARY

The present disclosure relates generally to systems and methods for the secure management of digital or electronic information relating to a user. More specifically, the present disclosure relates to systems and methods for sharing and aggregating digital or electronic information related to a user between one or more devices.

As the electronic communications infrastructure improves worldwide, the distribution of digital content is being rapidly transformed, aided by efficient digital media formats, the economies of digital storage technologies, and peer-to-peer and group-oriented social networks. For example, Internet and mobile TV provide new distribution capabilities for video and may now be linked to numerous other Internet-based services. In certain instances, content distribution technologies may be linked to advertising services to support the intelligent distribution and monetization of digital content.

Ad-based content distribution systems may be used to help fund the production of content, the services that distribute the content, and/or the devices that render the content. To maximize the benefit of ad-based content distributions systems, ads delivered to a consumer should ideally be well-matched to the consumer. That is, an opportunity for ad impression should be optimized to ensure that the ad is well-matched to the interests of the consumer. Moreover, the overhead for delivering the ad and making the match should be minimized.

Systems and methods disclosed herein facilitate efficient targeting of ads to a user using information related to the user. Such information may be used to ensure that ads are delivered to a user that are well matched to the user's interests. For example, personal information provided by a user and/or generated based on a user's activities may be used to effectively match ads to the interests of the user. In many instances, a device used by the user to consume content may obtain such personal information. For example, a user may provide personal identification information (e.g., age, gender, and the like) and/or content preference information (e.g., preferred genres, artists, and the like) to a mobile electronic device used to consume content. Based on the personal information, the device, a content provider or distributor, and/or a trusted third party may target ads to the user matched to user interests identified based on the personal information.

In many circumstances, users may use multiple devices to consume content. For example, a user may use a mobile phone, personal digital assistant (“PDA”), a portable media player, a computer system, and/or an Internet-enabled television to consume content. Consistent with embodiments disclosed herein, personal information related to a user may be managed, shared, and/or aggregated between one or more devices used by the user to consume content. By sharing and/or aggregating personal information between multiple devices, collected personal information related to a user may better reflect the user's interests, and ad targeting and matching services that use the personal information may be improved. In still further embodiments, systems and methods disclosed herein may be used to ensure privacy and/or security of personal information relating to a user.

### BRIEF DESCRIPTION OF THE DRAWINGS

The inventive body of work will be readily understood by referring to the following detailed description in conjunction with the accompanying drawings, in which:

FIG. 1 illustrates an exemplary system for distributing advertisements and electronic content consistent with embodiments of the present disclosure.

FIG. 2 illustrates an exemplary system for implementing embodiments of the present disclosure.

FIG. 3 illustrates an exemplary system for delivering certified attributes to an electronic device consistent with embodiments of the present disclosure.

FIG. 4 illustrates sharing of user personal information between devices consistent with embodiments of the present disclosure.

FIG. 5 illustrates sharing of anonymized personal information between devices consistent with embodiments of the present disclosure.

FIG. 6 illustrates aggregation of personal information between devices consistent with embodiments of the present disclosure.

FIG. 7 illustrates exemplary an architecture of a system for distributing advertisements and electronic content consistent with embodiments of the present disclosure.

FIG. 8 illustrates exemplary elements used in a certificate policy framework consistent with embodiments of the present disclosure.

FIG. 9 illustrates distribution of policies between a clearinghouse and client devices consistent with embodiments of the present disclosure.

FIG. 10 illustrates a framework for peer-to-peer communication consistent with embodiments of the present disclosure.

FIG. 11 illustrates a client device implementing a personal agent consistent with embodiments of the present disclosure.

FIG. 12 illustrates exemplary traffic routing in an overlay network consistent with embodiments of the present disclosure.

### DETAILED DESCRIPTION

A detailed description of systems and methods consistent with embodiments of the present disclosure is provided below. While several embodiments are described, it should be understood that the disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

The embodiments of the disclosure may be understood by reference to the drawings, wherein like parts may be designated by like numerals. The components of the disclosed embodiments, as generally described and illustrated in the figures herein, could be arranged and designed in a wide variety of different configurations. Thus, the following detailed description of illustrative embodiments of the systems and methods of the disclosure is not intended to limit the scope of the disclosure, as claimed, but is merely representative of possible embodiments of the disclosure. In addition, the steps of any method disclosed herein do not necessarily need to be executed in any specific order, or even sequentially, nor need the steps be executed only once, unless otherwise specified.

Systems and methods are presented for collecting and managing personal digital or electronic information related to a user using one or more devices. In certain embodiments, the systems and methods described herein can, for example, be used in connection with advertisement (“ad”) matching and/or advertisement targeting technologies such as those described in commonly assigned co-pending U.S. patent application Ser. No. 12/785,406, “Content Delivery Systems and Methods,” filed May 21, 2010, and published as U.S. Pub. No. 2010/0293049 A1 (“the '406 application”), which is incorporated herein by reference in its entirety. To efficiently target advertisements to a particular user, a platform may obtain information regarding the user. In some circumstances, this may create a conflict between users and an advertisement service provider as a user may not wish to reveal much private information, whereas the service provider typically will want to collect as much information as possible. Embodiments of the systems and methods described in the '406 application may help to resolve such conflict by maintaining a user's information locally on an electronic device and/or in remote storage protected by a user's personal agent, while simultaneously making such information available for an ad matching engine running locally on the user's device and/or remotely on a secure system. As a result, such a platform may protect a user's private information even while this information is used to target ads or other information to a user.

In further embodiments, the systems and methods described herein can, for example, be used in connection with digital rights management (“DRM”) technologies such as those described in commonly assigned, co-pending U.S. patent application Ser. No. 11/583,693, “Digital Rights Management Engine Systems and Methods,” filed Oct. 18, 2006 and published as U.S. Pub. No. 2007/0180519 A1 (“the '693 application”), service orchestration and DRM technologies such as those described in commonly assigned U.S. Pat. No. 8,234,387, “Interoperable Systems and Methods for Peer-to-Peer Service Orchestration” (“the '387 patent”), peer-to-peer (“P2P”) content sharing technologies such as those described in commonly assigned, co-pending U.S. patent application Ser. No. 12/784,290, “Content Sharing Systems and Methods,” filed May 20, 2010, and published as U.S. Pub. No. 2010/0299522 A1 (“the '290 application”), and/or advertisement targeting technologies such as those described in commonly assigned, co-pending U.S. patent application Ser. No. 12/433,881, “Data Collection and Targeted Advertising Systems and Methods,” filed Apr. 30, 2009, and published as U.S. Pub. No. 2009/0298480 A1 (“the '881 application”), (the contents of the '693 application, the '387 patent, the '290 application, and the '881 application hereby being incorporated by reference in their entireties), as well as in other contexts. It will be appreciated that these systems and methods are novel, as are many of the components, systems, and methods employed therein.

Embodiments of the systems and methods disclosed herein may be used to search for, gather, and/or maintain information about a user (e.g., personal information). As a user interacts with devices and services, personal information may be obtained related to a user including, for example, demographic information about the user (e.g., age, gender, etc.), the usage history and preferences of the user, information about the user's device(s), content preference information (e.g., preferred genres, artists, etc.), and/or other information about the user or the user's environment (e.g., time of day, global positioning system (“UPS”) coordinates, etc.). In some circumstances, this personal information may be volunteered directly by a user. For example, in registering a device, a user may voluntary provide personal demographic information to a device manufacturer and/or service provider. Personal information related to a user may also be obtained by monitoring the user's use of devices and/or services.

As discussed above, personal information provided by a user and/or generated based on a user's activities may be used to effectively match ads to the interests of the user. This may be achieved utilizing, for example, the ad-matching technologies described in the '406 application. In certain embodiments, this ad-matching may be performed locally on a user's device. Alternatively, ad-matching may performed by a trusted third party. Further, in circumstances where a user uses multiple devices and/or services to consume content, personal information may be managed, shared, and/or aggregated between the devices and/or services to generate a more detailed and accurate profile of the user's interests. By improving the ability to generate a more detailed profile of a user's interests, managing personal information related to the user between multiple devices can improve ad-matching services.

In the context of managing, sharing, and aggregating personal information between multiple devices and/or services, the confidentiality of certain private personal information related to the users should be maintained. In some circumstances, maintaining confidentiality of personal information may be mandated by local laws, privacy regulations, and/or by user preference. Accordingly, systems and methods may be deployed that allow for managing the confidentiality of user personal information. In some embodiments, this may be achieved by ensuring that certain personal information is not communicated outside of a user's devices, accounts, or a trusted boundary associated with the user. Additionally, anonymous versions of personal information may be generated that can be managed, shared, and aggregated between multiple devices without compromising user privacy. Further, users may specifically restrict access to certain categories and/or types of personal information, while allowing the sharing and aggregating of other types of personal information, through one or more articulated policies. Employing such techniques may allow for improved ad-matching services while maintaining the confidentiality of certain user personal information.

Embodiments of the systems and methods described herein can be used to search for, gather, and/or maintain information about a consumer for use, for example, by systems such as those described in the '406 application as well as in other contexts. For example, some embodiments of the systems and methods described herein can be used to search through information available on a consumer's device, such as media items and browser bookmarks, and build a user profile, possibly in combination with other information such as user volunteered information and/or the like.

In some embodiments, client software on a user's device may track a user's local usage behavior and save raw data related to such local usage. In some embodiments, such raw data can be protected locally, aggregated periodically to update a user profile, and/or aggregated across different devices associated with the consumer to update a user profile. The updated user profile may be used locally and/or remotely for purposes of ad targeting and/or for purposes of transmission to the user of virtually any other type of content or information (e.g., coupons, offers, rights to content, tickets, entertainment content, etc.). In certain embodiments, the user profile may be used in an anonymous or protected form.

Some users may have reservations about technology that records their behavior and reports it to third-party organizations. For example, a user may be concerned that their preferences and/or content consumption behavior will be used against them in some way (e.g., they may be discriminated against based on their cultural preferences, political preferences, etc.) and/or that it might cause embarrassment if it became publicly known or distributed to certain parties (e.g., employers, family members, etc.).

Embodiments of the systems and methods described herein can be used to address these concerns in a number of ways including, for example, by providing users with an opportunity to opt-in and/or opt-out of data collection services, and/or limiting the transmission of collected data to trusted services (e.g., locally and/or in the cloud). For example, in some embodiments, personally identifiable information (“PII”) that is collected may not be permitted to be transmitted from a device. Rather, profile information that may lack specific enough information to personally identify a particular user may be shared with a remote device or service. In some embodiments, users may be shown information that may be transmitted from their electronic device before it is transmitted. In further embodiments, users may be shown information that may be transmitted from their electronic device if they choose to do so via entries made to a log file.

In still further embodiments, data may be reported without a unique ID associated with a user. Similarly, electronic device playlist requests, ad-lists, and/or the like may be generated without use of a unique ID. In certain embodiments, non-personality identifiable information may be transmitted from an electronic device by ad-matching software executing on the device. In yet further embodiments, support for an overlay network may be provided that reduces the likelihood of any backend service tracking users via IP addresses through anonymization of client IP addresses. In certain embodiments, an overlay network may comprise a network built on top of another network that includes, for example, a plurality of nodes connected by one or more virtual and/or logical links. In some embodiments, an overlay network can be used for a variety of purposes, including, e.g., the generation and/or distribution of anonymized playlists, ad-lists, PII, and/or usage data.

Content and Advertisement Distribution Architecture

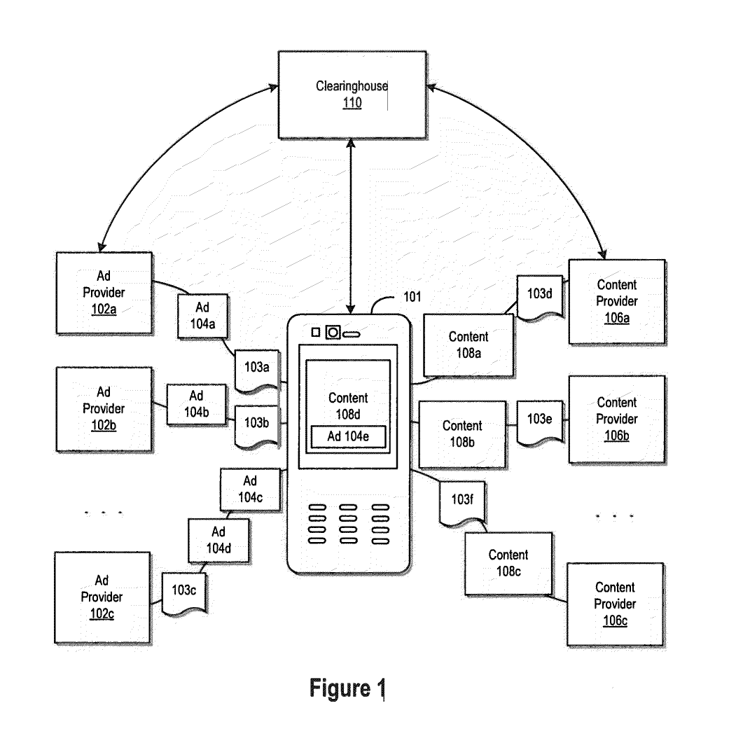

FIG. 1 illustrates an exemplary system 101 for distributing advertisements 104 and electronic content 108 consistent with embodiments of the present disclosure. In certain embodiments, the illustrated system 101 may employ the ad-matching technologies described in the '406 application. As shown in FIG. 1, a user's system 101 may receive a variety of advertisements 104a, 104b, 104c, 104d, 104e from a variety of advertisement providers 102a, 102b, 102c. The user's system 101 may also receive a variety of other content items 108a, 108b, 108c, 108d from a variety of content providers 106a, 106b, 106c. When the user makes use of a piece of content 108d, the user's system may dynamically choose an optimal advertisement 104e from the advertisements 104a-104e that it previously received, and present that advertisement 104e to the user in connection with the piece of content 108d. Information about the user, the user's device, and the user's content preferences and content usage habits can be used in the advertisement selection process. In addition, information about which advertisements were rendered can be collected and sent to one or more clearinghouses and/or other remote services (e.g., clearinghouse 110) to facilitate the provision of payment or other compensation from advertisers 102 to content owners or providers 106. Alternatively, or in addition, such information could be sent directly from the user's device to the content provider 106 and/or advertisement provider 102.

The content provider 106 may comprise a content owner, creator, or distributor, such as a musician, movie studio, publishing house, software company, author, mobile service provider, Internet content download or subscription service, cable or satellite television provider, an employee of a corporation, a content aggregator, a content retailer, or the like, or an entity acting on behalf thereof, and content 108 may comprise any electronic content, such as digital video, audio, or textual content, a movie, a song, a video game, a piece of software, an email message, a text message, a word processing document, a web page, a report, an electronic book or periodical, and/or any other entertainment, enterprise, and/or other content.

In the example shown in FIG. 1, ad providers 102 and/or content providers 106 may associate licenses 103 with distributed content 108 and/or advertisements 104. In certain embodiments, a license 103 may be based on the policies or other wishes of ad providers 102 and/or content providers 106, and may specify permitted and/or prohibited uses of the associated content or advertisement, and/or one or more conditions that must be satisfied in order to make use of the content or advertisement, or that must be satisfied as a condition or consequence of use. In some embodiments, a license 103a may specify whether a recipient of content item 108a is required to view advertisements and, if so, the criteria that an advertisement should satisfy in order to be selected. Similarly, a license 103a associated with a particular advertisement 104a, or a group or category of advertisements, may specify the types of content with which the advertisement may be played or otherwise integrated, and/or the remuneration or other compensation that entity 102a is willing to provide if advertisement 104a is integrated with a particular type of content 108.

Content 108, advertisements 104, and/or licenses 103 may be secured by one or more cryptographic mechanisms, such as encryption or digital signature techniques or any other security protections specified by a DRM system (if any) being used, and a trust authority (e.g., clearinghouse 110) may provide appropriate cryptographic keys, certificates, and/or the like. In some embodiments a DRM system such as those described in the '387 patent and/or the '693 application is used.

Content 108, advertisements 104, and/or licenses 103 can be provided to a user device 101 by any suitable means, such as via a network like the Internet, a local area network, a wireless network, a virtual private network, a wide area network, and/or the like; via cable, satellite, broadcast, or cellular communication; and/or via recordable media such as a compact disc (“CD”), digital versatile disk (“DVD”), Blu-ray Disc, a flash memory card (e.g., a Secure Digital (“SD”) card), and/or the like. Content 108 can be delivered to the user together with a license 103 in a single package or transmission, or in separate packages or transmissions received from the same or different sources.

The user's system 101 (e.g., a personal computer, a mobile telephone, a television and/or television set-top box, a portable audio and/or video player, a PDA, an electronic book reader, and/or the like) may contain application software, hardware, and/or special-purpose logic that is operable to retrieve and render content 108. The user's system 101 also may include software and/or hardware, referred to herein as a digital rights management engine, for evaluating the licenses 103 associated with content 108 and/or advertisements 104 and enforcing the terms thereof (and/or enabling a content rendering application to enforce such terms), and software and/or hardware for selecting appropriate advertisements to render in connection with use of content 108, and gathering and reporting information related thereto. In certain embodiments, selecting appropriate advertisements to render in connection with the use of content 108 may use the ad-matching technologies described in the '406 application. The user's system 101 may further include software and/or hardware configured to securely store and/or manage confidential personal information related to the user.

A digital rights management engine and/or ad matching engine may be structurally or functionally integrated with each other, and/or with a content rendering application, or may comprise separate pieces of software and/or hardware. Alternatively, or in addition, a user's system may communicate with a remote system (e.g., a server, another device in the user's network of devices, such as a personal computer or television set-top box, and/or the like) that uses a digital rights management engine and/or ad matching engine to make a determination as to whether to grant the user access to content previously obtained or requested by the user, and whether and which advertisements to render in connection therewith.

A digital rights management engine, and/or other software or hardware on the user's system or in remote communication therewith, may also record information regarding the user's access to or other use of protected content and/or advertisements. In certain embodiments, this information may include personal information relating to the user and/or the user's interests. In some embodiments, some or all of this information might be communicated, potentially in anonymous form, to a remote party (e.g., a clearinghouse 110, the content creator, owner, or provider 106, the user's manager, an entity acting on behalf thereof, and/or the like) for use, for example in allocating revenue (e.g., revenue such as royalties, advertisement-based revenue, etc.), determining user preferences, enforcing system policies (e.g., monitoring how and when personal information is used), and/or the like.

As shown in FIG. 1, content 108 need not be distributed together with advertisements 104 (or licenses 103). Advertisements 104 can be separately provided, and integrated with content 108 dynamically by the user's system 101. This integration may be done in accordance with rules encoded in the licenses 103 associated with the content 108, the advertisements 104, and/or provided by the user or system regarding the type and quantity of advertisements that may or must be integrated with the content, and/or the types of content with which an advertisement may be rendered. In preferred embodiments, the system is configured to optimize the matching of ads with content by using personal information related to a user including, for example, some or all of: demographic information about the user (e.g., age, gender, etc.), the usage history and preferences of the user, information about the user's device(s), and/or other information about the user or the user's environment (e.g., time of day, GPS coordinates, etc.). In certain embodiments, ad-matching may be performed locally on the user's system 101 or on a remote server under the user's control (e.g., in storage associated with the user on a server maintained by a trusted party). Accordingly, personal information used in ad-matching can be securely maintained on the user's system, and need not necessarily be transmitted to third parties, thus protecting the user's privacy while enabling accurate targeting of advertisements. In further embodiments, to protect a user's privacy, anonymous versions of some of the personal information may be securely communicated to other devices and/or a clearinghouse 110 for redistribution to content providers and/or ad providers to facilitate the future provision of content and ads of potential interest to the user.

It will be appreciated that a number of variations can be made to the architecture and relationships presented in connection with FIG. 1 within the scope of the inventive body of work. For example, without limitation, in some systems, some or all of the content may be delivered together with some advertisements, the content and advertisements may be delivered to the user's system from a single source (e.g., a television service provider), and/or a piece of content may be integrated with multiple advertisements. In some embodiments, the determination of which advertisement(s) to present in connection with a piece of content can be performed by a remote system, and/or the integration of the advertisements and the content can be performed remotely, and the integrated content and advertisements then transmitted to the user's system for display or other rendering. Thus it will be appreciated that FIG. 1 is provided for purposes of illustration and explanation, and not limitation.

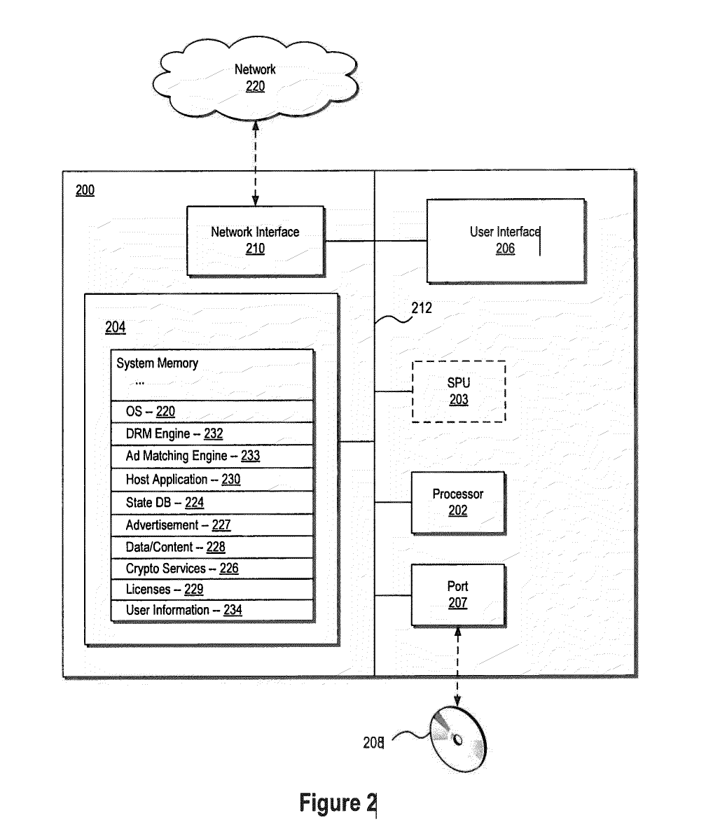

FIG. 2 illustrates an exemplary computer system for implementing embodiments of the present disclosure. For example, system 200 might comprise an embodiment of a user's device, a trusted service system (e.g., a clearinghouse), an advertisement provider's computing system, a content provider's system, and/or the like. The exemplary system 200 may comprise a general-purpose computing device such as a personal computer or network server, or a specialized computing device such as a cellular telephone, PDA, portable audio or video player, electronic book reader, tablet, television set-top box, kiosk, gaming system, and/or any other system configured to implement the systems and methods described herein.

As illustrated in FIG. 2, system 200 may include: a processor 202; system memory 204, which may include high speed random access memory (“RAM”), non-volatile memory (“ROM”), and/or one or more bulk non-volatile computer-readable storage mediums (e.g., a hard disk, flash memory, etc.) for storing programs and other data for use and/or execution by the processor 202; a user interface 206 that may include a display and/or one or more input devices such as, for example, a touchscreen, a keyboard, a mouse, a track pad, and the like; a port 207 for interfacing with removable memory 208 that may include one more diskettes, optical storage mediums, and/or other computer-readable storage mediums (e.g., flash memory, thumb drives, USB dongles, compact discs, DVDs, etc.); a network interface 210 for communicating with other systems via a network 220 such as, for example, the Internet, a local area network, a virtual private network, and/or the like using one or more communication technologies (e.g., wireless, Ethernet, infrared, Bluetooth®, etc.); one or more sensors (not shown) that may, e.g., comprise one or more location sensors; and one or more buses 212 for communicatively coupling the aforementioned elements.

In some embodiments, the system 200 may, alternatively or in addition, include a secure processing unit (“SPU”) 203 that is protected from tampering by a user of system 200 or other entities by utilizing secure physical and/or virtual security techniques. An SPU 203 can help enhance and/or facilitate the security of sensitive operations such as trusted credential and/or key management, privacy and policy management, and other aspects of the systems and methods disclosed herein. In certain embodiments, the SPU 203 may operate in a logically secure processing domain and be configured to protect and operate on secret information. In some embodiments, the SPU 203 may include internal memory storing executable instructions or programs configured to enable the SPU 203 to perform secure operations. In some embodiments, an SPU such as described in commonly-assigned U.S. Pat. No. 7,430,585 (“the '585 patent”) and/or U.S. Pat. No. 5,892,900 (“the '900 patent”) could be used.

The operation of system 200 may be generally controlled by the processor 202 and/or 203 operating by executing software instructions and programs stored in the system memory 204. The system memory 204 may include both high-speed RAM and non-volatile memory such as a magnetic disk and/or flash EEPROM. Further, some portions of the system memory 204 may be restricted, such that they cannot be read from or written to by other components of the system 200.

As shown in FIG. 2, the system memory 204 of the computing device 200 may include a variety of programs or modules, which, when executed by the processor 202 and/or the SPU 203, can control the operation of computing device 200. For example, the system memory 204 may include an operating system (“OS”) 220 for managing and coordinating in part system hardware resources and providing common services for execution of various applications. The system memory 204 may further include: a host application 230 for rendering protected electronic content; an ad matching engine or module 233 for performing aspects of the ad selection and matching functionality described herein; and a DRM engine 232 for implementing some or all of the rights management functionality described herein. In some embodiments, DRM engine 232 may comprise, interoperate with, and/or control a variety of other modules, such as a virtual machine for executing control programs, and a state database 224 for storing state information for use by the virtual machine, and/or one or more cryptographic modules 226 for performing cryptographic operations such as encrypting and/or decrypting content, computing hash functions and message authentication codes, evaluating digital signatures, and/or the like. The system memory 204 may also include protected data and/or content 228, advertisements 227, and associated licenses 229, user information 234, as well as cryptographic keys, certificates, and the like (not shown). In further embodiments, the system memory 204 may include any other functional module configured to implement the systems and methods disclosed herein when executed by the processor 202 and/or SPU 203.

One of ordinary skill in the art will appreciate that the systems and methods described herein can be practiced with computing devices similar or identical to that illustrated in FIG. 2, or with virtually any other suitable computing device, including computing devices that do not possess some of the components shown in FIG. 2 and/or computing devices that possess other components that are not shown. Thus it should be appreciated that FIG. 2 is provided for purposes of illustration and not limitation.

User Personal Information

As users consume content and/or use devices and/or services, personal information related to the user may be obtained. In certain embodiments, this personal information may reflect in part the interests of the user. Personal information may be provided by a user and/or be generated based on the user's activities. For example, a user may provide a client device used to consume content with personal identification information (e.g., age, gender, and/or the like) and/or content preference information (e.g., preferred genres, artists, and/or the like). Similarly, a client device may passively collect personal usage information regarding the types of content a user consumes, the number of times certain content is consumed, and/or the like. Collectively, personal information may include, without limitation, user attributes such as gender, age, content preferences, geographic location, attributes and information associated with a user's friends, contacts, and groups included in a user's social network, information related to content usage patterns (including, e.g., what content is consumed), content recommendations, ad viewing patterns, and/or the like. Based on the personal information, the device, a content provider or distributor, and/or a trusted third party may target ads or other content to the user matched to user interests identified or inferred from the personal information utilizing, for example, the technologies described in the '406 application.

User personal information may be generally classified into categories such as some or all of the following non-exclusive set of examples: certified attributes, usage data, user-volunteered personal information, shared user personal information, and/or aggregated user personal information, each of which is described in more detail below.

Certified Attributes

Client devices may store certified attributes acquired by users from trusted services that can authenticate certain attributes related to the user (e.g., attributes relating to age, gender, education, club membership, employer, frequent flyer or frequent buyer status, credit rating, etc.). In certain embodiments, certified attributes may be delivered to a user's devices as Security Assertion Markup Language (“SAML”) assertion(s). In some embodiments, to ensure privacy, attribute information may not be not shared. In such embodiments, attribute information may be used locally on a user's device. Alternatively, attribute information may be shared with other devices and/or entities that are trusted by the user. For example, trusted entities and/or services may use shared attribute information to refine the attributes, to derive new attributes, and/or to screen ads as part of a trusted service that the consumer subscribes to (e.g., via a registration process or the like). Devices may also generate and/or collect other attributes from various user events including, for example, metrics or attributes derivable from a user's history of interactivity with ads, purchasing history, browsing history, content rendering history, and/or the like. Further, a variety of environmental attributes may also be stored, such as time of day, geographic location, speed of travel, and/or the like.

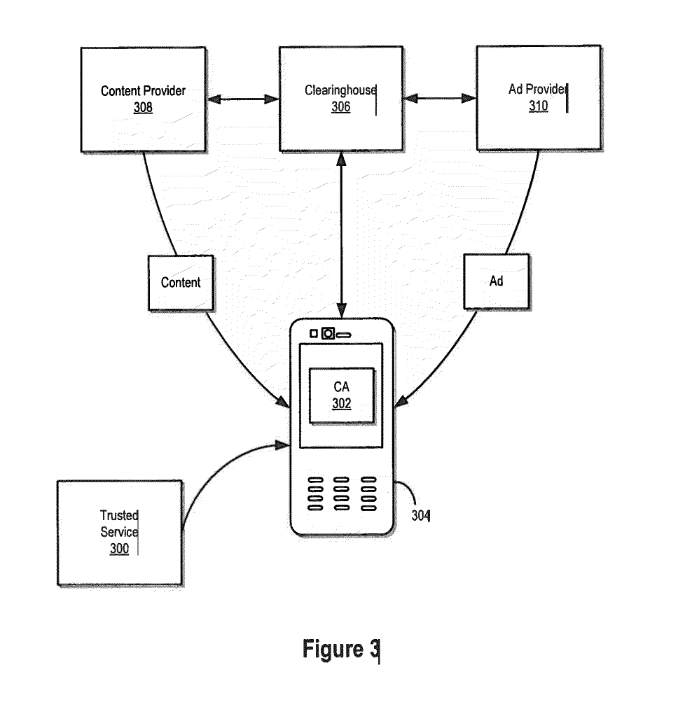

FIG. 3 illustrates an exemplary system for delivering certified attributes 302 to a user's electronic device 304 consistent with embodiments of the present disclosure. In certain embodiments, a trusted service and/or third party 300 may issue a certified attribute 302 (e.g., a SAML Assertion/Statement) to the device 304 of a user that subscribes to its service. For example, an automobile association may issue a certified attribute 302 to the device 304 of a member. Once issued, the certified attribute 302 may be stored by the user's device 304 and used to certify that the user is a member of the automobile association a variety of contexts and/or applications.

A trusted clearinghouse 306 may receive an indication from the user's device 304 that it possesses the certified attribute 302 issued by the trusted service 300 (e.g., an assertion that the user is a member of the trusted service 300). In certain embodiments, the clearinghouse 306 may coordinate with a content provider 308 and/or an ad-provider 310 in administering content and/or ad-matching services. For example, the clearinghouse 306 may keep track of certified attributes 302 associated with the user's device 304. Further, services offered by the clearinghouse 306 may enable a content provider 308 and/or an ad-provider 310 to determine whether the user should be matched with particular content and/or a particular advertisement based on known certified attributes 302 associated with the user's device 304. For example, in certain embodiments, the clearinghouse 306 may allow a content provider 308 and/or an ad-provider 310 to pre-screen for users that possess certain certified attributes 302 in order to target and deliver advertisements offering special promotions. If a user has interest in a targeted delivered ad and proceeds to participate in the special promotion, the certified attribute 302 stored on the user's device may be used to determine that the user is in fact eligible to participate in the special promotion (e.g., that the user is a member of an eligible organization or the like).

Certified attributes 302 may also be used locally on a user's device 304 to perform ad-matching services utilizing, for example, the ad-matching technologies described in the '406 application. In embodiments where ad-matching is performed locally, certified attributes 302 may be accessed by an ad-matching application executing on the user's device 304 and used in a local ad-bidding process. For example, an ad-provider may pay a premium for ads targeted to users that are members of the automobile association. An ad-matching application executing locally on the user's device 304 may determine that a user is a member of the automobile association based on possession of a certified attribute 302 indicating the same. Based on this determination, the premium ad content may be delivered to the user, thereby increasing revenue from ad-providers.

Usage Data

Personal information may include usage data information related to a user's content usage habits. Usage data may include information regarding the types of content a user consumes, the number of times certain content is consumed, metrics or attributes derivable from a user's history of interactivity with ads and/or content, purchasing history, browsing history, content rendering history, and/or the like. In certain embodiments, usage data may be generated locally on a user's device through monitoring of a user's interaction with the device (e.g., as content is consumed and/or the user performs other actions using the device). Alternatively or in addition, usage data may be generated by a trusted third party (e.g., a content provider, an ad provider, and/or a clearinghouse) capable of monitoring a user's interaction with a device and/or delivery of items to the device. In some embodiments, usage data may be stored locally on an electronic device in a secure manner to protect the integrity of the data and/or be filtered suitably to ensure that it is anonymized in some way before it is transmitted from the device (e.g., to a clearinghouse or other external service).

User-Volunteered Personal Information

Certain personal information may be volunteered (e.g., provided directly) by a user. For example, in registering or configuring a device, a user may voluntarily provide personal demographic information to a device, a device manufacturer, and/or a service provider. In certain embodiments, this information may include a user's age, gender, contact information, address, field of employment, and/or the like. User-volunteered personal information may also include content preference information (e.g., preferred genres, preferred artists, etc.). In some embodiments, in lieu of or in addition to collecting personal information as part of a device registration or configuration process, user-volunteered personal information may be provided by a user when registering with a service or at various times during a user's interaction with a device (e.g., concurrent with selection of a particular piece of content).

Volunteering personal information may provide certain benefits to users. In some embodiments, a clearinghouse, a content provider, and/or an ad provider may allow certain premium content and/or ads to be consumed by a user who volunteers personal information of an increased value to the clearinghouse, content provider, and/or ad provider. For example, an ad provider may wish to specifically target ads to users in a particular age demographic, and thus may reward users who volunteer their age with access to premium content. In lieu of or in addition to premium content, premium offers or promotions may be provided. In certain embodiments, the valuable personal information may allow the content provider, the ad-provider, and/or other trusted services to improve the ability to match and target ads or other content to the user. Offering premium content, advertisements, offers, or promotions thus incentivizes users to voluntarily provide more valuable personal information, thereby increasing the effectiveness of ad targeting and matching.

In the context of ad-matching services, user-volunteered personal information may be treated differently than other types of user personal information (e.g., certified attributes or usage data). Particularly, because user-volunteered personal information may not be certified or verified, it may be considered less accurate for use in assessing a user's interests. Accordingly, in certain embodiments, user-volunteered personal information may be weighted as less important in making ad-matching determinations than other certified or verifiable user personal information.

Shared User Personal Information

Users often consume content on multiple devices. For example, a user may utilize an electronic reading device to consume textual content, a portable media player to consume short duration audio and/or video content, and an Internet-enabled television to consume long duration video content. Though different interactions with a user and/or third party services, different devices may obtain different personal information. For example, a portable media player may obtain a significant amount of usage information whereas an electronic reading device may obtain a significant amount of user-volunteered information through interaction with a user and/or third party services.

Maximizing the amount of user personal information that can be utilized for ad-matching and targeting services may increase the overall effectiveness of such services. Therefore, sharing user personal information between multiple devices, clearinghouses, and/or trusted third parties may be desirable. Personal information shared between devices, clearinghouses, and/or trusted third parties may be generally referred to as shared user personal information.

In certain embodiments, sharing personal information between devices clearinghouses, and/or trusted third parties may require that participating entities utilize secure communication methods and policies to help protect the confidentiality of shared user personal information. For example, devices, clearinghouses, and/or trusted third parties may be required to authenticate that they are within a certain boundary of trust before communicating shared user personal information with other devices. In certain embodiments, device, clearinghouse, and/or third party authentication may be achieved using P2P content sharing technologies such as those described in the '290 application.

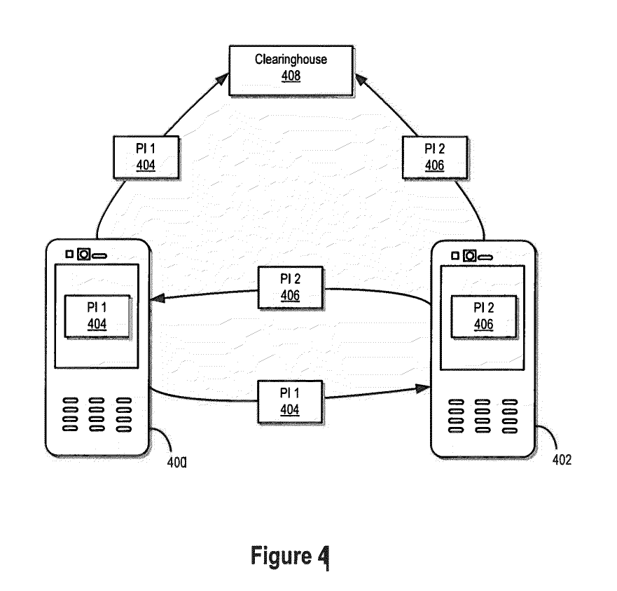

FIG. 4 illustrates sharing of user personal information between devices 400, 402 consistent with embodiments of the present disclosure. As illustrated, device 400 may generate, store, and/or maintain personal information denoted as “PI 1” 404, and device 402 may generate, store, and/or maintain personal information denoted as “PI 2” 406. Personal information 404, 406 may include usage data generated through a user's interaction with devices 400, 402 respectively, user volunteered personal information, and/or any other type of user personal information, including PII.

In certain embodiments, prior to sharing personal information 404, 406, devices 400, 402 may authenticate each other to determine that they are within a certain boundary of trust and/or authorized to receive personal information using any suitable authentication and/or authorization technique. For example, in some embodiments, device 400 may determine that device 402 is in possession of a trusted credential, a certified attribute, and/or any other indicia of trust indicating that device 402 is authorized to receive personal information associated with a user of device 400. Once it is determined that device 402 is authorized to receive the personal information, PI 1 404 may be transmitted from device 400 to device 402, e.g., via any suitable communication method (e.g., wired communication, wireless communication, and/or the like). Device 402 may similarly share PI 2 406 with device 400 upon authenticating that device 400 is authorized to received PI 2 406.

In certain embodiments, devices 400, 402 may share personal information (e.g., PI 1 404 and PI 2 406) with a trusted clearinghouse 408. The clearinghouse 408 may, among other things, coordinate with a content provider and/or an ad-provider in administering ad-matching services utilizing personal information shared by devices 400, 402. For example, the clearinghouse 408 may maintain personal information shared by devices 400, 402 and offer services that may enable a content provider and/or an ad-provider to determine whether a user associated with devices 400, 402 should be matched with particular content or a particular advertisement based on shared personal information. In some embodiments, prior to sharing personal information with the trusted clearinghouse 408, devices 400, 402 may authenticate that the clearinghouse 408 is within a certain boundary of trust and/or authorized to receive personal information using any suitable authentication and/or authorization technique

As discussed in more detail below, in certain embodiments, sharing of personal information may be restricted and/or controlled by one or more articulated policies. For example, in certain embodiments, a policy may articulate that only certain types of personal information may be shared with other devices and/or parties (e.g., with a clearinghouse). A policy may further articulate that only anonymized and/or otherwise filtered personal information may be shared.

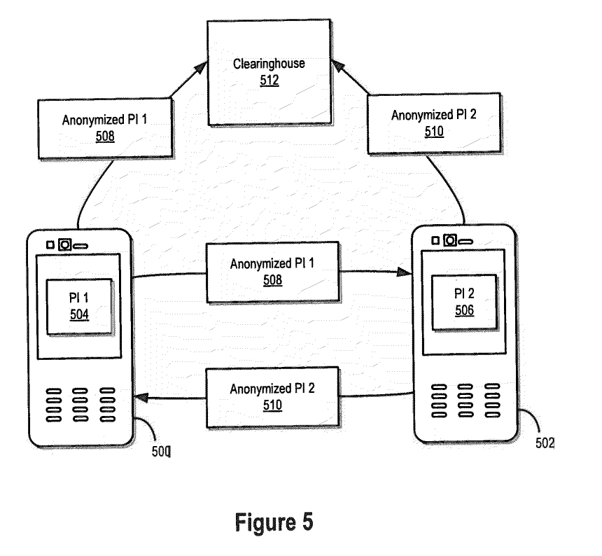

FIG. 5 illustrates sharing of anonymized personal information between devices 500, 502 consistent with embodiments of the present disclosure. As illustrated, devices 500, 502 may generate, store, and/or maintain personal information 504, 506 respectively. Personal information 504, 506 may include usage data generated through a user's interaction with devices 500, 502 respectively, user volunteered personal information, and/or any other type of user personal information.

In certain embodiments, prior to sharing personal information 504, 406, devices 500, 502 may anonymize and/or otherwise filter the personal information 504, 506. In some embodiments, anonymizing the personal information may comprise removing and/or filtering certain PII information from personal information 504, 506, such that shared information transmitted from a device may not be used to uniquely identify (e.g., identify with a certain degree of specificity) the user of a device. For example, prior to sharing personal information 504 with device 502 and/or clearinghouse 512, device 500 may generate anonymized personal information 508. Anonymized personal information 508 may include personal information associated with a user of the device 500 that may be used in ad-targeting and/or content distribution methods disclosed herein, but not include PII and/or other information that may be used to uniquely identify the user. For example, in certain embodiments, anonymized personal information 508 may include certain usage data relating to device 500, but not include a user's name, address, and/or any other PII. Similarly, prior to sharing personal information 506 with device 500 and/or clearinghouse 512, device 502 may generate anonymized personal information 510.

Aggregated Personal Information

In certain embodiments, personal information can be anonymized and/or aggregated locally and/or at a remote service, such as a clearinghouse, that stores, maintains, and/or manages aggregated data. For example, personal information may be aggregated based on a category that a device and/or a user belongs to. In some embodiments, categorizing devices and/or users may allow for improved content and/or advertisement targeting as devices and/or users may be pre-screened and/or pre-filtered to receive certain content and/or advertisements.

In some embodiments, aggregating personal information may increase the effectiveness of ad and/or content targeting. Aggregating personal information over time may enable a service to successively refine and/or improve device and/or user categorization. For example, in certain embodiments, a service may utilize aggregated personal information in conjunction with results of ad and/or content targeting over a period of time to improve the matching of user interests to content and advertising.

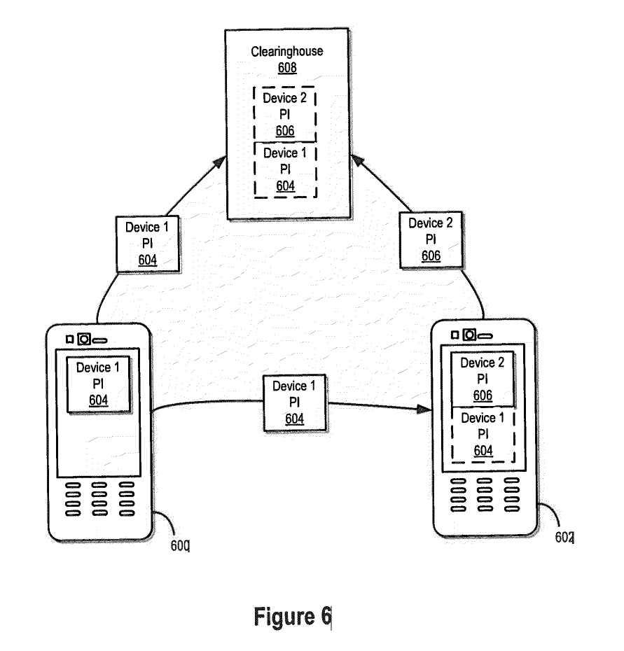

FIG. 6 illustrates aggregation of personal information between devices 600, 602 consistent with embodiments of the present disclosure. In some embodiments, aggregated personal information may be used to build a more robust and/or granular profile relating to a user's interests. As illustrated, device 600 may generate personal information 604. Personal information 604 may include usage data generated through a user's interaction with device 600, user volunteered personal information, and/or any other type of user personal information. Device 602 may generate personal information 606, which may also include usage data generated through a user's interaction with device 602, user volunteered personal information, and/or any other type of user personal information.

In certain embodiments, a user associated with device 600 may also be associated with device 602. Accordingly, personal information 604, 606 may be shared and/or aggregated between devices 600, 602 consistent with the systems and methods disclosed herein. For example, as illustrated, personal information 604 generated by device 600 may be shared with device 602 and aggregated with personal information 606 generated by device 602. In this manner, consistent with embodiments disclosed herein, device 602 may possess additional and/or utilize a greater variety of personal information relating to a user's interests for use in connection with ad targeting and other services. In certain embodiments, prior to sharing personal information for aggregation, devices 600, 602 and/or third party services (e.g., clearinghouse 608) may authenticate each other to determine that they are within a certain boundary of trust and/or authorized to receive personal information using any suitable authentication and/or authorization technique.

In certain embodiments, personal information generated by devices 600, 602 may also be aggregated by one or more trusted services including, for example, a clearinghouse 608. The clearinghouse 608 may, among other things, coordinate with a content provider and/or an ad-provider in administering ad-matching services utilizing personal information shared by devices 600, 602. For example, the clearinghouse 608 may aggregate personal information 604, 606 shared by devices 600, 602 respectively. In some embodiments, prior to sharing personal information with the clearinghouse 608, devices 600, 602 may authenticate that the clearinghouse 608 is within a certain boundary of trust and/or authorized to receive personal information 604, 606 using any suitable authentication and/or authorization technique

User Profiles

Embodiments of the systems and methods disclosed herein may be applied to a large set of devices with varying degrees of storage capacity, processing power, and network connectivity, and can be used for providing innovative services for targeted advertising and trusted remote event monitoring that leverage local information for ad/content matching and/or for other purposes. As discussed above, as users interact with devices and services, a user's device may learn and/or acquire certain information about the user's preferences and tastes to build personal information for use in facilitating further interactions with the ecosystems. In certain embodiments, such personal information may be associated with a user profile.

In some embodiments, a portion of a user profile may contain PII, while certain other aspects of the profile may not include PII and/or be used to uniquely identify a particular user. Local laws and/or regulations as well as user-selected preferences may prohibit the sharing and dissemination of PII. Non-PII may not be subject to such strict rules and may be shared in a limited way to provide a richer user-experience. Accordingly, systems and methods disclosed herein may provide for a way of protecting PII while distributing non-PII through various profile distribution and/or anonymization techniques.

Systems and methods disclosed herein may facilitate sharing and aggregation of user profile information for use, for example, in systems such as those described in the '406 application designed to be utilized by a large variety of consumer devices. For example, embodiments disclosed herein may be implemented in mobile handsets, set-top boxes, PDAs, ultra mobile personal computers (“UMPCs”), PCs, media gateway devices, and/or the like. Such devices may interact with multiple services that participate in a content and/or advertisement ecosystem allowing the devices to download advertisements and content.

Systems and methods disclosed herein may interact with a large number of service entities. For example, on the advertisement side, these entities may include direct advertisers, ad-networks, and/or ad exchanges that auction ad space to a wide range of advertisers. On the content side, service entities may include, for example, content creators, content publishers, content aggregators, content retailers, and/or the like.

In one embodiment, as users consume content, a usage profile that tracks the usage patterns may be built on a user's device. Local laws, privacy regulations, and user-preferences can be used to determine whether and in what manner this data will be shared with the outside world. Moreover, local content on the device may contain certain data that should not be shared with the outside world. Accordingly, systems and methods disclosed herein may also manage the sharing of content and/or associated data to ensure protection of personal information.

In certain embodiments, a platform such as that described in the '406 application can be used to enable advertisers to target their advertisements based on a user profile. For example, in some embodiments, advertisements may be matched to one or more ad slots locally on a device and make use of local content stored on the device. In other embodiments, this matching can be performed remotely. The system may ensure that usage data is shared within the system in accordance with local laws, privacy regulations, and/or user-articulated preferences or policies. For example, privacy regulations may articulate that certain PII should never leave a device or that such information should be sent through an anonymizer to remove PII before it is transmitted from the device. Local laws may articulate that a user needs to approve of sharing of PII before PII is shared with third-party entities (e.g., third party advertising services or the like). Further, users may restrict certain categories and/or types of information from being shared with other entities and/or devices while allowing sharing of certain other categories and/or types of information. In certain embodiments, the system may ensure that these considerations are followed while collecting, using, and sharing information about the user.

Policy-Driven Systems and Methods

Embodiments of the systems and methods disclosed herein may be utilized to ensure that some or all of the above-described considerations for collection and sharing of personal information, including PII, are followed through one or more personal information collection and/or sharing policies that govern these activities. For example, in some embodiments, rules regarding the collection and/or distribution of personal information may be articulated in one or more policies enforced by the systems and/or devices in a content and/or advertisement ecosystem. Such a policy-driven system may, among other things, enable the automated collection and sharing of personal information in accordance with local laws and regulations and/or user preferences. In some embodiments, personal information may be aggregated by a clearinghouse and shared appropriately with one or more service providers. Shared personal information may be used to pre-filter advertisements and/or to monitor the effectiveness of ad-targeting to better match the user's interests with advertisements that the user may be interested in without impinging on the privacy of the user. In certain embodiments, such pre-filtering may be improved and refined over time to improve the experience of the user.

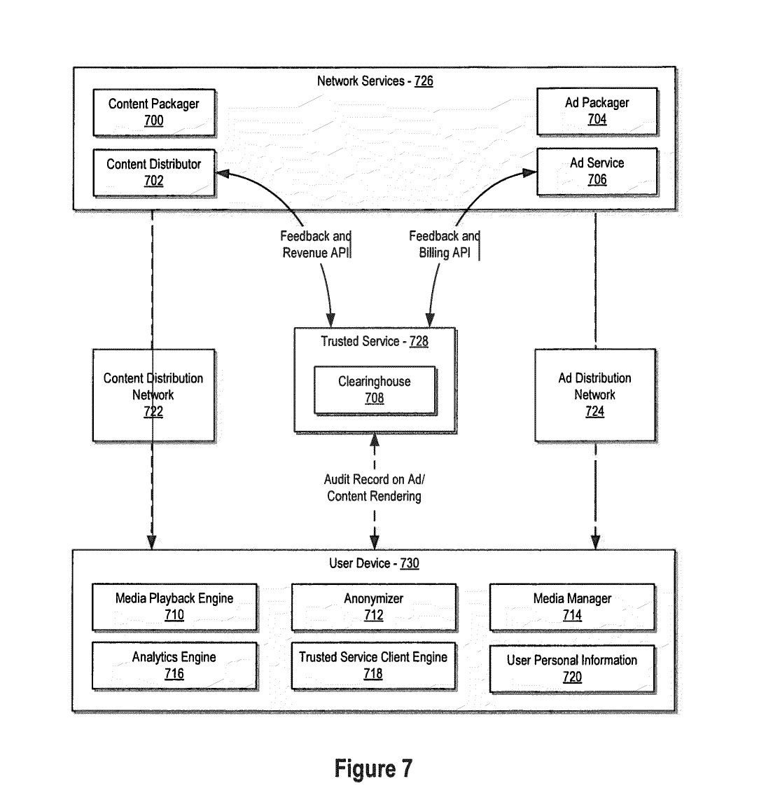

FIG. 7 illustrates an exemplary architecture of a system for distributing advertisements and electronic content consistent with embodiments disclosed herein. As illustrated, one or more network services 726 may interact with a trusted service 728 and/or a user device 730 (e.g., a client device). In some embodiments, the network services 726 may include a content packager 700 configured to package content and/or a content distributor 702 configured to distribute content to a user device 730 (e.g., via a content distribution network 722 or the like). The network services 726 may further include an ad packager 704 and/or an ad service 706 configured to generate and distribute advertisements to user device 730 (e.g., via an ad distribution network 724). In certain embodiments, network services 726 may coordinate with a trusted service 728 and/or a user device 730 in implementing certain ad targeting and matching services as disclosed herein.

The user device 730 may include a media playback engine 710 configured to render content delivered to the user device 730 by the content distributor 702 via the content distribution network 722. In certain embodiments, the user device 730 may further include a media manager 714 configured to manage content stored and/or rendered on the user device 730. The user device 730 may generate and/or store personal information 720 relating to the user. Such personal information 720 may include, e.g., certified attributes, usage data, user-volunteered personal information, shared user personal information, aggregated user personal information, and/or any other suitable type of personal information that may be used in performing certain ad targeting and matching services as well as in other contexts.

An anonymizer 712 may be included on the user device 730 configured to perform certain anonymization and/or filtering operations on certain personal information 720 transferred from and/or shared by the user device 730 with one or more third parties consistent with the embodiments disclosed herein. For example, anonymizer 712 may be configured to remove PII from personal information 720 prior to sharing the information with a remote device or service.

In some embodiments, the user device 730 may include a trusted service client engine 718 configured to, among other things, perform local ad matching and/or rendering services on the user device 730 consistent with the embodiments disclosed herein. For example, using personal information 720, trusted service client engine 718 may select an ad provided by ad provider 706 for rendering in connection with content provided by content distributor 702 targeted to the interests of a user of the device 730. In certain embodiments, the user device 730 may further include an analytics engine 716 configured to perform a variety of analytics-related services including, for example, analytics regarding the effectiveness of ad-targeting operations performed by the user device 730 and/or the trusted service client engine 718.

As discussed above, the network services 726 and/or the user device 730 may interface with one or more trusted services 728. The trusted service 728 may, among other things, include a clearinghouse 708 configured to facilitate the provision of payment or other compensation from advertisers and content owners and/or distributors. For example, using audit records on ad or content rendering provided to the trusted service 728 by the user device 730, the trusted service may facilitate appropriate payment to content distributor 702 and/or an ad provider 706 via an appropriate feedback, revenue and/or billing API.

In certain embodiments, data flows within the system may occur in a policy-driven manner. In some embodiments, this may allow for the system to comply with local laws, privacy regulations, and/or user preferences regarding the sharing and aggregation of personal information. As discussed above, user profile information stored in a device may include PII as well as non-PII. User profile information may flow into the device ecosystem disclosed herein from a variety of sources. In certain embodiments, profile information may be classified into categories (e.g., certified attributes, usage data, user-volunteered information, shared profile information, aggregated information, and/or the like) based on the origin of the information.

User attributes may be delivered to a device in the form of certified attributes. In some embodiments, certified attributes may be implemented using a SAML assertion. Additionally or alternatively, attributes may be delivered as an agent operable to set attributes in a protected database such as that described in the '693 application or the '406 application. For example, a third party may issue a SAML assertion to its members as proof of membership (e.g., using a SAML attribute statement). This SAML assertion may be delivered to and stored by a client device. A clearinghouse may be used to track membership information to enable advertisers to pre-screen users for ad-targeting (e.g., by offering special promotions to users of such devices). If a user likes a targeted advertisement offer and proceeds to purchase, the SAML assertion stored on the device may be used as proof of membership while redeeming the targeted offer.

A SAML assertion stored on the device may also be used as local context when advertisers engage in a bidding process performed locally on a user's device. For example, in certain embodiments, an advertiser may engage in a local bidding process for a particular ad-slot in connection with rendered content. The SAML assertion may be made available to an ad-bidding control program (e.g., as a tree of host objects containing the SAML attributes) and a control program executing on the user's device may be capable of using this membership information to bid higher for an ad-slot if the user is a member of a particular targeted organization. This may enable advertisers to bid higher for the opportunity to present an advertisement in a particular ad-slot if the user is the desired target audience for the advertiser's marketing message.

In another example, an agent program such as that described in the '693 application may be delivered to a user's device by a service. The agent may, among other things, populate a local database on a user's device with an attribute indicating that the user is a member of a third party service. In certain embodiments, this attribute may be stored in a service level container in the database for the service. A flag may be set on the attribute indicating that the attribute and/or path segments under the service level container that lead to the attribute can be read so that controls signaled by other principals can be allowed access to the data (e.g., read-only access).

In some embodiments, an advertisement may be associated with an ad-bidding control signed by a trusted party (e.g., a clearinghouse). The ad-bidding control may be programmed so that it will bid high for an ad-slot if the user is a member of a particular service such, for example, as the AARP. When the ad-bidding control is executed, it may determine that a user is a member of the AARP and bid high for a particular ad-slot based on the determination. In some embodiments, this behavior of the ad control may allow it to bid higher in pursuit of an opportunity to render an ad on a device having a user associated with an intended audience.

In certain embodiments, sharing and aggregation of personal information and/or policies may allow for automatic selection of what content to download and what advertisements to show a user, thereby enabling users to automatically obtain content that they prefer and be shown advertisements for products they are interested in. In further embodiments, when devices are located within a certain proximity of each other (e.g., within the range of a wireless communication system or the like), the devices may be securely bound. In some embodiments, this binding may be automatic. Once bound, the devices may exchange content, advertisements, and/or personal information utilizing certain systems and methods disclosed herein, thereby providing P2P distribution of content and advertisements. In some embodiments, such an operation may reflect the way users behave and interact with content, as users may consume content and/or view advertisements using a variety of mobile devices.

Data Collection Policies

In some embodiments, a personal information collection policy on a device may be used to control aspects of what information is collected by the device and how such information is collected. For example, the policy may be used to control what types of personal information are collected, the conditions under which the personal information is collected, how the personal information may be used on a device, limitations on collected of personal information (e.g., how many days of personal information should be collected, how long it should be retained, size limits on collected information, whether users can set/modify these limits, whether users can opt-in/opt-out of collection activities, any/or any other desired limitations), and/or the like.

Data Filtering and Sharing Policies

In some embodiments, a personal information filtering and sharing policy may be enforced by a device to control certain aspects of how personal information is shared and/or used by other devices and/or services. For example, a personal information filtering and sharing policy may articulate aspects regarding how personal information is shared, whether personal information and/or portions thereof may be transmitted from the device, how personal information and/or portions thereof may be used outside of the device, how personal information is filtered (e.g., anonymized) before transmission to other devices and/or services (e.g., what types of personal information are filtered, what types of personal information should be transformed and/or altered, what transmission methods are allowed, how filtering and/or sharing should be implemented, etc.), and/or the like.

Personal Information Aggregation Policies

In some embodiments, a personal information aggregation policy may be enforced by a device to control certain aspects of how personal information is aggregated and/or used by other devices and/or services. For example, a personal information aggregation policy may articulate how devices and/or services are allowed to transmit and/or receive and aggregate personal information, how frequently and/or at what intervals devices may transmit personal information to third party services for aggregation, how devices and/or services may utilize the aggregated personal information, and/or the like.

Various types of policies in addition to those described above may also be implemented by client devices and/or services. Further, in some embodiments, any suitable combination of various types of policies, including the policies described above, may be implemented as a single policy. Policies may include a variety of rules including, for example, rules that give users the choice to opt-in and/or opt-out of personal information collection, rules that specify that only anonymized personal information from which certain PII has been removed can be sent to external services for aggregation, and/or the like. In some embodiments, aggregated personal information may be used to improve a service offering for all users who collectively are members of an aggregate group, without a way to directly identify a particular user and/or impinge on a user's privacy.

Mechanisms for User-Profile Information Sharing

Embodiments of the systems and methods disclosed herein may be utilized to provide a policy framework and mechanism to implement user-profile information sharing. In some embodiments, certificates may be associated with certificate-policies that stipulate how a certificate may be used. For example, with X.509v3 certificates, a certificate policy may be associated with the certificate through a certificate policies extension. This extension may contain a unique, registered certificate policy object identifier (“OID”) field that may identify the certificate policy, and optional policy-dependent information in a qualifier field.

In certain embodiments X.509 may not mandate a purpose for which a qualifier field is to be used. In some embodiments, Public-Key Infrastructure X.509 (“PKIX”) Part I may define two elements in the qualifier field—namely a certification practice statement (“CPS”) pointer and a user notice qualifier. The CPS pointer may be a user resource identifier (“URI”) that points to the CPS and the user notice qualifier. The CPS may describe practices employed by a certification authority (“CA”) in issuing the certificate. The user notice qualifier may include a text statement that may be displayed to a user prior to use of the certificate.

In one embodiment, X.509v3 certificates may be used in connection with the systems and methods disclosed herein. In some embodiments, a policy object identity of the certificate may be used to identify a certificate policy specifying how a certificate may be used. In some embodiments, the certificates can contain extensions pertaining to key usage and other constraints including, for example, specifying processing rules for validation of the certificate.

It will be appreciated that any suitable mechanism can be used to express the articulated policies disclosed herein. For example, many alternatives exist for expressing policy statements including, for example, controls of the type described in the '693 application, XACML, XrML, KeyNote, and/or the like.

In one embodiment, a link between a certificate policy object identifier and an actual certificate policy may not be hardcoded into a certificate but can, for example, be obtained via indirection from a CPS document which lists the certificate policies supported by the CPS. The certificate policy may be dynamically updated and the CPS may contain rules about how and when the applications that parse and understand policies should check for updates via specification change procedures of the CPS.

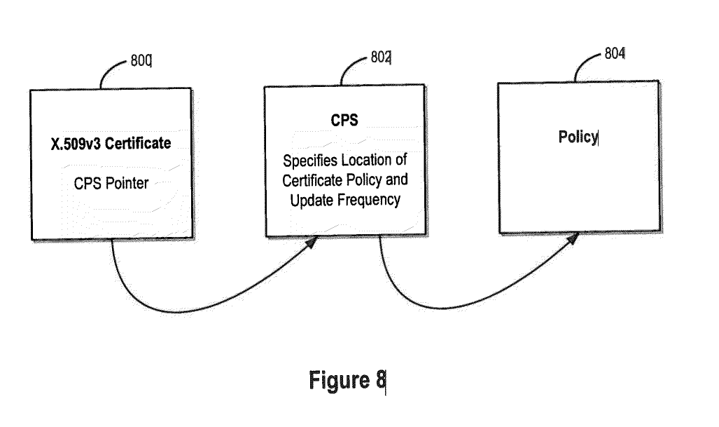

FIG. 8 illustrates exemplary elements 800-804 used in a certificate policy framework consistent with embodiments of the present disclosure. The illustrated elements may include a certificate 800 (e.g., an X.509v3 certificate), a CPS 802, and a certificate policy 804. In some embodiments, the location of the policy statement, which may be expressed in any suitable manner, may be hardcoded into an application. In certain embodiments, an update interval and/or change frequency of the policy 804 may be obtained from the specification change procedures in the CPS 802. In further embodiments, an update interval and/or change frequency of the policy 804 may be hardcoded if the interval and/or frequency is not expected to change.

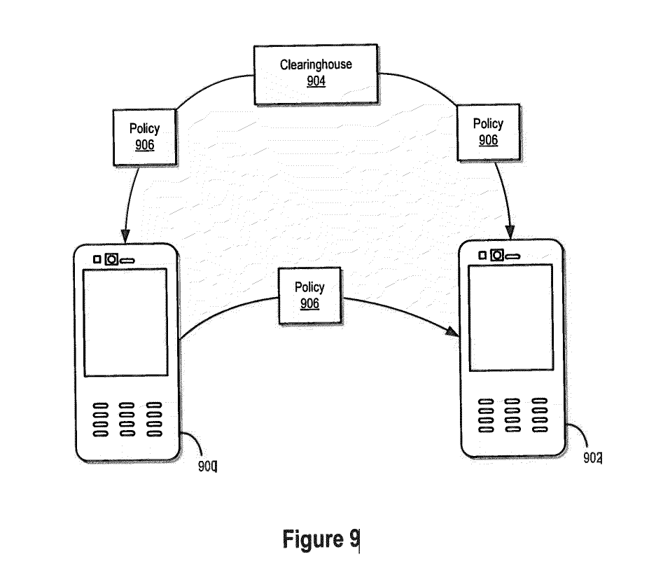

In some embodiments, a clearinghouse or other service may be used to publish a CPS and/or a certificate policy that specifies rules for data collection, data filtering/sharing, and/or data aggregation. Client devices may download and store the policy and enforce it locally. FIG. 9 illustrates distribution of policies 906 between a clearinghouse 904 and devices 900, 902 consistent with embodiments disclosed herein. As illustrated, the devices 900, 902 may receive a policy 906 published by a clearinghouse 904. Updated policies issued by the clearinghouse 904 or other suitable service may be distributed to devices 900, 902 similarly. In yet further embodiments, policies 906 may be generated and/or exchanged between one or more devices 900, 902 directly.

In certain embodiments, the policies 906 may be associated with a user of devices 900, 902. In further embodiments, different policies 906 may be distributed to each of devices 900, 902 (e.g., device specific policies) reflecting, among other things, users preferences regarding the use of personal information in relation to devices 900, 902. In some embodiments, polices 906 may be embodied as certificate policies.

Policies, including certificate policies, established by a clearinghouse 904, or other devices and/or services may control a variety of actions including, without limitation:
How a device obtains a certified policy to use locally.
How a device stores policies locally.
How a device enforces a policy locally.
How a device updates locally stored policies.

For example, if a service uses a “pull” model for policy updates, a policy may control how frequently and/or at what interval should a device check for updates to the policy. Similarly, if a service uses a “push” model, a policy may control what the mechanism is for delivery of an updated policy to the device.

In one embodiment, a personal information collection, filtering, anonymization, and/or sharing policy may be established using a certificate policy and/or a CPS. In such an embodiment, a policy may specify a distribution point (e.g., a URL) from which a client device could obtain a certified policy for collection, filtering, anonymization, and/or sharing of personal information. The policy may further specify how it should be stored locally and/or enforced by the client device. In some embodiments, the policy may specify how the locally stored policy should be updated.

In certain embodiments, policies may be implemented by coding logic in a client application or a client application software development kit (“SDK”). Any other suitable mechanism, however, may also be utilized. For example, in some embodiments, a distribution point and/or an update interval and/or frequency (e.g., if using a “pull” model for policy updates) may be specified as a field in a custom policy information certificate extension which may, for example, include the following fields:

| Field Name | Format | Description |
|---|---|---|
| Data Collection Policy | Null terminated | The URL from which |
| Distribution Point | string (e.g., URL) | the client downloads |
| | that points to a | certified data collection |
| | certified client | policies |
| | policy for data | |
| | collection | |
| Data Filtering Policy | Null terminated | The URL from which |
| Distribution Point | string (e.g., URL) | the client downloads |
| | that points to a | certified data filtering |
| | certified client | policies |
| | policy for data | |
| | filtering | |
| Update Interval | 32-bit integer | The recommended interval |
| | | in seconds between client |
| | | update checks |

As discussed above, policies for personal information and/or profile sharing may be downloaded to a client device and evaluated locally for enforcing user-profile information sharing rules. In some embodiments, the same and/or similar policy language(s) in use on a service backend may also be used on a client device. In further embodiments, different policy languages or expression mechanisms may be used (e.g., expression mechanisms more well-suited for low-power and lower-capability client devices). For example, control programs of the type described in the '693 application may be used to provide a way of achieving a lightweight implementation of policy statements that can be evaluated using a relatively small and compact virtual machine interpreter similar to that used by a DRM engine such as described in the '693 application.

In one embodiment utilizing control programs such as those described in the '693 application, upon evaluation, an action in a control would return an extended status byte (“ESB”). As described in the '693 application, the ESB may be a flexible, variable length data structure that may be used to express a policy in terms of data-structures that are mutually intelligible to a service and an application. In certain embodiments, processing rules on a client device can specify how the client device stores a certified policy locally. For example, such processing rules might specify that a downloaded certified policy should be stored on persistent storage. The policy may be certified and integrity protected automatically.

In some embodiments, a default policy may be provided that is applicable across one or more services, and individual services may define their own policies that override the default policy. For example, in an embodiment using control programs similar to those described in the '693 application, a policy for data collection may be evaluated by a client device using a fixed, pre-determined control program to evaluate the policy. The fixed control program may have a special control action to evaluate the policy. While rendering content from the service, a device may execute the special control action. The control logic in the action may first determine whether there is a service-specific data collection policy and, if there is no service-specific data collection policy, default to the default policy. For the selected policy (e.g., service-specific and/or default), the control may call a virtual machine with an ID of the selected policy. For example, in the nomenclature used in the '693 application:

Top of Stack

ID of Control (Data Collection Policy)
IdentifyRequirementsBlockAddress
. . .

If a naming convention for control IDs is used where the subject of the control signer certificate is used as the control ID prefix, then the identity of the signer of the IdentityRequirementsBlock can be deduced form the ID of the control itself.

Next, the logic may call a virtual machine with the module handle obtained above (e.g., with an entry point of “Control.Actions.Evaluate.Policy”). The callee may specify a sufficiently large return buffer address to accept the result from the call (e.g., the ESB):

Top of Stack

VmHandle
EntryPoint
ParameterBlockAddress
ParameterBlockSize
ReturnBufferAddress
Return Buffer Size
. . .

Finally, the fixed control program may release the virtual machine (e.g., by calling ReleaseVM( )) and return the ESB it received from the spawned control to the host program. The host program may utilize the ESB and collect personal information in accordance with rules and/or policies received in the ESB. Similar mechanisms may be utilized for filtering and/or anonymization of personal information.

Client Policy Updates

In some embodiments, policies may be updated using a pull model, in which a host may refresh and/or update a policy based on, for example, an update interval in a certificate extension, on a schedule coded in the client device, and/or on a schedule set by a user. Alternatively or in addition, policies may be updated in accordance with a push model, in which a policy may be transmitted to a client device from a service and/or clearinghouse.

P2P Sharing

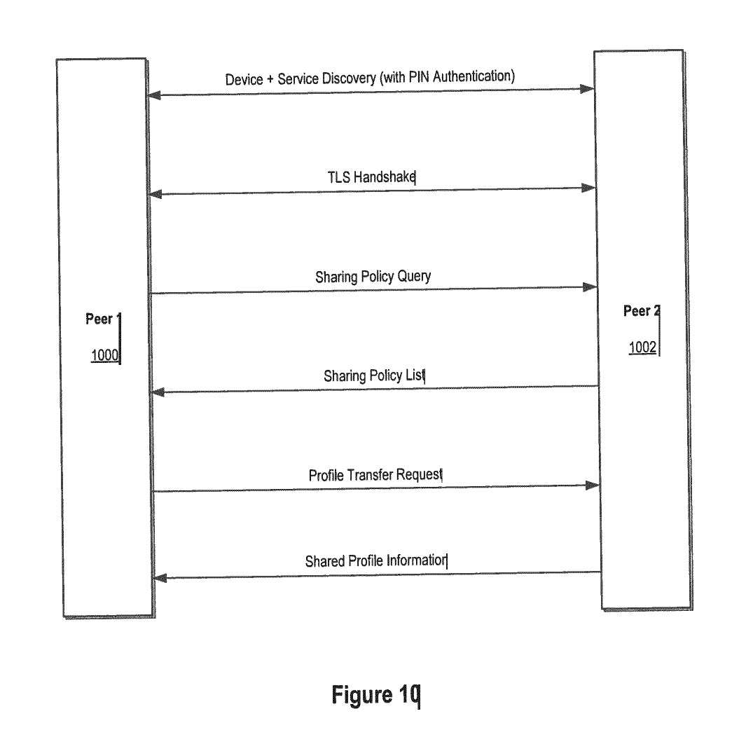

Certain embodiments disclosed in the '881 and the '290 application describe systems and methods that may allow for controlled P2P sharing of DRM protected content when client devices bond with each other (e.g., wirelessly bond using Bluetooth and/or any other suitable wireless communication technology). Embodiments of the systems and methods disclosed herein may be utilized in the context of controlled P2P sharing to enable sharing of personal information and profile information in accordance with one or more articulated policies. In some embodiments, certificates and/or keys may be utilized by client devices to communicate over transport layer security (“TLS”) links. FIG. 10 illustrates a framework for P2P communication consistent with embodiments disclosed herein.

When devices exchange information (e.g., using mechanisms described in the '881 and/or the '290 applications), devices may already be authenticated to each other via PIN authentication and/or other authentication mechanisms. In some embodiments, such authentication may occur during a device and/or service discovery process (e.g., a Bluetooth® device and/or service discovery process). For example, as illustrated in FIG. 10, a first peer 1000 and a second peer 1002 may engage in a device and/or service discovery process and exchange one or more TLS handshakes. During the process of binding, PINs may be required on both devices 1000, 1002 being bound. This PIN may, for example, be a random self-selected PIN which can be different each time any two devices connect. In some embodiments, this may ensure that the devices are authenticated to each other, thereby thwarting potential man-in-the-middle (“MITM”) attacks. Consistent with embodiments disclosed herein, certificate policies may be updated to allow for P2P sharing (e.g., by updating certificate policy and CPS on a service side or the like).

In some embodiments, the exchange of user-profile information may, for example, use an application level protocol similar to those described in the '881 and '290 applications. In further embodiments, additional messages for user-profile information sharing may be utilized: SharingPolicyQuery and ProfileTransfer. In one embodiment, a SharingPolicyQuery message (e.g., issued by peer 1000) may be used by a device to request its peer (e.g., peer 1002) to send a list of sharing policies. In response, the peer (e.g., 1002) may send a list of sharing policies (e.g., a list indicating what types of information it is willing to share). The ProfileTransfer message can be used by a device (e.g., peer 1000) to select a particular policy from the list it received and to ask for the information as per the policy. In response, a peer (e.g., peer 1002) may send an ESB structure and/or other structure containing requested information (e.g., personal information) and/or meta-data relating to the requested information.

Personal Agent

In certain embodiments, many decisions may be based on analysis derived from information collected from a variety of sources such as user metadata (e.g., attributes, actions, recommendations, etc.), content metadata, and/or advertisement metadata. In some embodiments, a personal agent, such as that described in the '406 application, may be used to collect and/or store metadata from devices and other services a user interacts with (e.g., social networks and/or the like). A user's privacy may be maintained because only the personal agent has direct access to personal information relating to the user. Users may have control over what personal information is exposed form the personal agent to other entities. In certain embodiments, the personal agent may be used to mediate between advertisement providers and a user's personal information in a scalable manner.

In some embodiments, roles of a personal agent may include, without limitation, some or all of the following:
Data collection of information from a variety of sources associated with a user. Such sources may, in some embodiments, include data on a user(s) device (e.g., PCs, PDAs, mobile phones, etc.) and data associated with services that the user interacts with such as, for example, social networks. Collected data may be stored in a secure manner. For example, collected data may be stored in encrypted form.
Network services to support replicated data to the cloud for backup purposes and/or to support synchronization of data between different user devices.
Provide services to allow trusted entities to query information about users in a controlled and policy-managed way. The personal agent service may be used for a variety of purposes including, but not limited to, delivering targeted advertisements, deals, coupons, content recommendations, and/or the like.

In some embodiments, the type of personal information the personal agent may collect may be extensible and customizable based on user input, system policy, and/or characteristics of specific devices or platforms on which the personal agent is deployed. These may include, for example, some or all of the following:
User attributes such as gender, age, media type interest, geographical information, etc.
Attributes and information associated with user's friends and groups associated with social networks the user participates in.
Information associated with user content usage patterns such as, for example, what content a user consumes, content recommendations, advertisement viewing patterns, and/or the like.

A personal agent may be implemented in a variety of ways to collect, store, and/or manage personal information. In some embodiments, a personal agent may be implemented as an agent that runs locally on a device such as a background service configured to monitor events and collect information from a variety of sources including, for example, direct user input, user content, user actions, web browsing and/or searches, and/or the like. In further embodiments, a personal agent may be implemented as a network service that interacts with services (e.g., social networks and/or the like) and collects information related to a user's profile, friends, groups, recommendations, and/or the like.

In some embodiments, information sharing through a personal agent may be controlled to protect a user's privacy. User privacy may be protected in a variety of ways. A personal agent may support interfaces where a system and a user can specify a policy defining what personal information can be captured and/or for what purposes the information can be used. For example, a user may specify that their gender should never be captured and/or that any information about their age may be used for transient ad-targeting but not stored for later use by third parties.

Information may be stored and/or managed by a personal agent in a secure manner. For example, a personal agent may utilize encrypted databases to store personal information. Moreover, personal agent services running in the cloud may use enterprise service level security to protect personal information.

In some embodiments, a personal agent may be the only entity and/or service that has direct access to personal information. Any exposed personal information may be accessed via a governed personal agent interface that operates in accordance with policies specified by, e.g., the user. For example, a personal agent may only allow access to service interfaces by authorized entities such as authorized ad providers. In some embodiments, the personal agent may require users of service interfaces to authenticate themselves through a secure authentication process.

A personal agent may be utilized to implement certain personal information sharing, anonymization, and/or filtering techniques disclosed herein. For example, a personal agent may be used to filter certain details from personal information and/or to generate anonymous summaries of personal information. In certain embodiments, a personal agent may restrict the types of personal information allowed to be queried upon and restrict any answers to such queries based on policies. For example, a personal agent may not allow queries about certain user attributes such as gender or age. Further, a personal agent may restrict access to queries where response values are of a fixed set (e.g., only binary responses or the like).

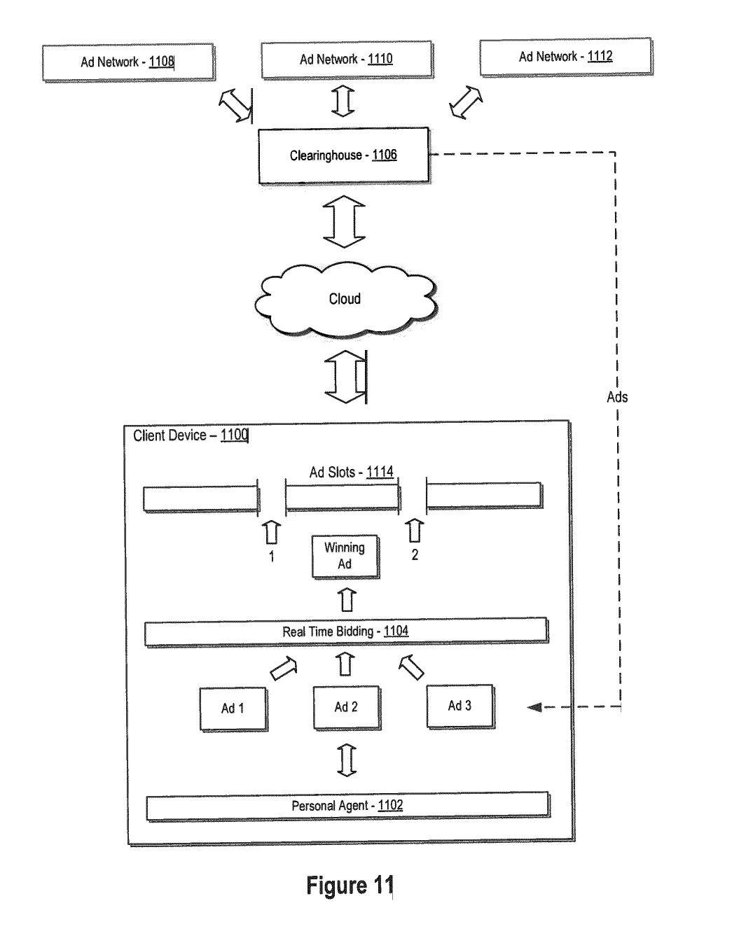

FIG. 11 illustrates a client device 1100 implementing a personal agent 1102 consistent with embodiments disclosed herein. As illustrated, the client device 1100 may include a personal agent 1102. In certain embodiments, the personal agent 1102 may collect, store, and/or manage personal and/or profile information stored on the client device. In further embodiments, the personal agent 1102 may be used to mediate between ad providers and a consumer's personal information. For example, the personal agent 1102 may interface with and/or implement a real-time bidding process 1104 locally on the client device 1100 configured to match one or more ads (e.g., “Ad 1”, “Ad 2”, and/or “Ad 3”) with one more ad slots 1114 through a bidding process designed to select a winning ad (e.g., an ad providing the most revenue to a content creator or the like). In certain embodiments, ads may be delivered to the client device via a remote and/or cloud-based clearinghouse 1106 that may have received the ads from one or more ad networks 1108-1112 and/or ad providers, although other suitable arrangements are also contemplated.

Overlay Networks

Overlay networks may be utilized to achieve anonymity of participants and/or peers in a network. In certain embodiments, overlay networks may be used to perform certain anonymization and/or sharing operations relating to personal information and/or profile information. The overlay network may create a virtual network on top of an ordinary network such as a TCPI/IP network, and each overlay network node may be connected to its peers in the overlay network by one or more virtual and/or logical connections.

Overlay networks may be utilized in IP anonymizer networks. In some overlay networks, a node may not communicate with Internet-based services directly, but instead may route the traffic through the overlay network. To a server, the requests may appear to originate from a number of IP address. Provided that a client does not transmit any PII (e.g., unique IDs, cookies, etc.), the client may be assured that its access of information over the Internet is anonymous. Anonymous P2P networks (e.g., I2P, Tor/Vidalia, Winny, etc.) may include open nets, where anyone can be a peer, and darknets, where only certain designated individuals (e.g., friends) can become peers. In some circumstances, anonymous overlay networks may be used for applications providing content sharing, anonymous browsing, anonymous messaging, and/or the like.

Anonymity may be viewed as orthogonal to confidentiality. Because a network is anonymous does not necessarily mean that information sent via the network is confidential. For example, routing nodes may be able to snoop and/or otherwise eavesdrop on a communication. Accordingly, confidentiality of a message may be ensured through implementation of one or more suitable encryption techniques.

If a session key used to encrypt a message using public key infrastructure (“PKI”) keys will not be compromised even if the private key is compromised in the future, the key-arrangement protocol may be described as having “forward secrecy.” Perfect forward secrecy (“PFS”) may exist if a session key is not compromised even if a subsequent session key derived from the same long-term keying material (e.g., PKI public/private key pairs) gets compromised. PFS may be a desirable property to have in an anonymous network protocol because it may ensure that actual messages exchanged will not be compromised and traced back to a sender even if a public key infrastructure PKI privacy key is broken.

In some embodiments, an anonymous P2P overlay network may be constructed using one or more clients as overlay network nodes (“ONNs”) communicating with each other in a P2P fashion. In certain embodiments, clients may include DRM software client applications as described in the '693 application, although it will be appreciated that in other embodiments, other types of clients could be used, including clients that do not include DRM software, or that include a different type of DRM software.

In certain embodiments, clients may include PKI keys, certificates, and/or secret keys that they may utilize to communicate with each other and/or with remote services. In some embodiments, clients may be tamper resistant and be trusted to correctly respond to P2P and client-server protocols. Compromised clients may be excluded, removed through a certificate revocation process, and/or otherwise shunned by other clients/and or services. An anonymous P2P network may be constructed by adapting client code from a network such as, for example, Tor, although it will be appreciated than an anonymous P2P network could be constructed in any suitable manner.

In some embodiments, implementing a special-purpose anonymous network to use with the advertising and content distributions systems and methods disclosed herein may allow for a network that is not subject to and/or affected by the actions of users who are not parties to the platforms. Further, such a network may include features including encryption, whereby payloads are encrypted to avoid eavesdropping, and tamper resistance to prevent or discourage users from tampering with network routing logic.

Any suitable protocol may be used for ONN discovery including, for example, protocols such as network address translator (“NAT”) punching that may make it possible for clients to discover and/or communicate with each other in a variety of circumstances (e.g., behind firewalls). In some embodiments, ONN clients may communicate using one or more keys/certificates and/or protocols such as those described in the '387 patent, the '881 application, and or the '290 application.

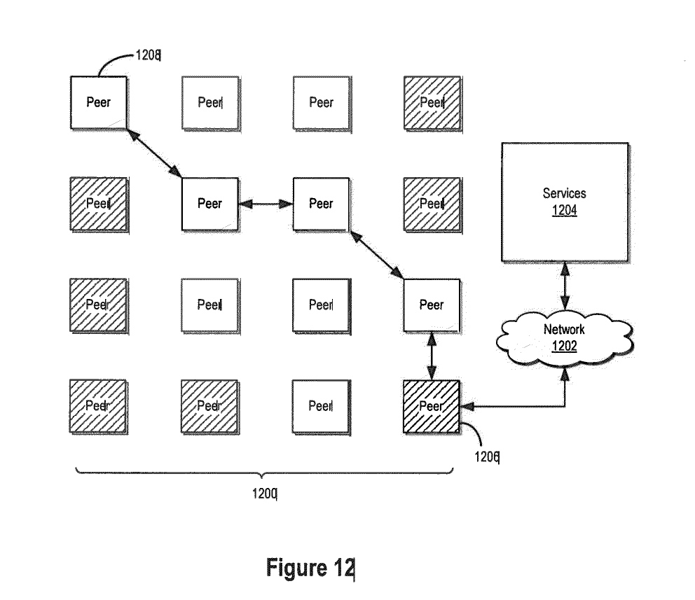

In certain embodiments, clients may be diversified but not be unique. In some embodiments, this may assist in anonymizing the clients to some extent, but there may still be a chance that one of the nodes that the traffic is routed through in the overlay-network may have the same and/or similar keys as a sender. This node may be able to snoop and/or otherwise eavesdrop on traffic. To circumvent this, in some embodiments, the route/node selection algorithm can be modified so that peers that are unlike the sender may be utilized in message routing. FIG. 12 illustrates exemplary traffic routing in an overlay network consistent with embodiments disclosed herein. As illustrated, a network may include a plurality of diversified peers 1200. Message traffic between a peer and a service 1204 connected via a network 1202 may be routed through at least one peer/node that is unlike the sending peer/node. For example, as shown, message traffic between peer 1208 and service 1204 may be routed through peer 1206, as peer 1206 may be different than peer 1208 in some manner. While illustrated as having multiple network hops, in some embodiments, routing may include any suitable number of network hops including single hops.

Payload Encryption

In some embodiments, a message payload may be encrypted using a server public key (e.g., via a protocol such as those described in the '387 patent) or other suitable payload encryption mechanism to prevent snooping and to provide confidentiality. In such embodiments, peer selection and/or message routing may still utilize different nodes because a response returned to a client may be encrypted using a client's public key and a like client may be able to decrypt and read the response. To achieve PFS, a session key may be established via a suitable protocol (e.g., by using a Diffie-Hellman key agreement). In further embodiments PFS may not be implemented. For example, PFS may not be implemented in situations where the nature of exchanged information may not be sensitive enough to warrant a PFS system. In some embodiments, where PFS is not required, a client's secret keys may be used to encrypt a payload.

Reporting Relay Path to a Client

Utilizing an anonymous P2P network may assure users that their data is reported anonymously and that their playlists, ad lists, and/or the like are queried and downloaded and/or uploaded anonymously. In one embodiment, to demonstrate anonymity to users in a transparent manner, a response that a client receives from a server may be stamped with their IP address (e.g., with signatures) and/or another suitable means of identification so that a client can see that a request was routed randomly and that the server did not receive any information that identified the origin of the data.

In certain embodiments, query data (e.g., requests/responses for playlist queries and ad list queries) may either be shown to a user and/or logged to a file so that a user can see what was sent on their behalf. Similarly, usage information that is to be uploaded to a server may be shown to a user and/or logged to a file so that an end user can see what data was sent on their behalf.

In some circumstances, law enforcement and/or other authorities may need to intercept certain communications. To facilitate this, systems and methods disclosed herein may allow certain authorized authorities to track traffic going into and exiting from an overlay network and/or to correlate and/or track possible suspects if needed. In addition, by using key distribution techniques such as those described, for example, in the '693 application, it would be possible to reveal a client's encryption keys (e.g., while still not revealing signing keys) so that law enforcement purposes may still be achieved. In some embodiments, PFS may be relaxed, and if a shared secret key (e.g., shared between a client and a server) is used to encrypt a payload, law enforcement may be given access to the shared secret key for the client to help perform necessary data collection.

Network Connections

Embodiments of the systems and methods disclosed herein may utilize a variety of network connections and/or communication protocols for communication. For example, services (e.g., trusted services), client devices, clearinghouses, and/or any other systems disclosed herein may communicate using one or more suitable network connections and/or communication protocols. Suitable network connections may include, without limitation, the Internet, a local area network, a virtual private network, and/or any other communication network utilizing one or more electronic communication technologies and/or standards (e.g., Ethernet or the like). In some embodiments, the network connections may comprise a wireless carrier system, such as a personal communications system (“PCS”), and/or any other suitable communication system incorporating any suitable communication standards and/or protocols. In further embodiments, the network connections may comprise an analog mobile communications network and/or a digital mobile communications network utilizing, for example, code division multiple access (“CDMA”), Global System for Mobile Communications or Groupe Special Mobile (“GSM”), frequency division multiple access (“FDMA”), and/or time divisional multiple access (“TDMA”) standards. In still further embodiments, the network connections may incorporate one or more satellite communication links and/or utilize IEEE's 802.11 standards, near-field communication, Bluetooth®, ultra-wide band (“UWB”), Zigbee®, and or any other suitable standard or standards.

Client Devices and Systems

Embodiments of the systems and methods disclosed herein may utilize a variety of devices and systems. For example, clients, services, clearinghouses, and/or any other suitable entities may be associated with one or more computing devices and/or systems suitable for implementing the systems and methods disclosed herein. In certain embodiments, such devices and/or systems may include, without limitation, laptop computer systems, desktop computer systems, sever computer systems, distributed computer systems, smartphones, tablet computers, PDAs, and/or the like. Such systems and devices may comprise at least one processor system configured to execute instructions stored on an associated non-transitory computer-readable storage medium to perform certain methods encoded herein. In some embodiments, devices and systems may further comprise a SPU configured to perform sensitive operations such as trusted credential and/or key management, secure policy management, and/or other aspects of the systems and methods disclosed herein. The devices and systems may further comprise software and/or hardware configured to enable electronic communication of information between the devices and/or systems via a network using any suitable communication technology and/or standard.

The systems and methods disclosed herein are not inherently related to any particular computer, electronic control unit, or other apparatus and may be implemented by a suitable combination of hardware, software, and/or firmware. Software implementations may include one or more computer programs comprising executable code/instructions that, when executed by a processor, may cause the processor to perform a method defined at least in part by the executable instructions. The computer program can be written in any form of programming language, including compiled or interpreted languages, and can be deployed in any form, including as a standalone program or as a module, component, subroutine, or other unit suitable for use in a computing environment. Further, a computer program can be deployed to be executed on one computer or on multiple computers at one site or distributed across multiple sites and interconnected by a communication network. Software embodiments may be implemented as a computer program product that comprises a non-transitory storage medium configured to store computer programs and instructions, that when executed by a processor, are configured to cause the processor to perform a method according to the instructions. In certain embodiments, the non-transitory storage medium may take any form capable of storing processor-readable instructions on a non-transitory storage medium. A non-transitory storage medium may, for example, be embodied by a compact disk, digital-video disk, a magnetic tape, a magnetic disk, flash memory, integrated circuits, or any other non-transitory digital processing apparatus memory device.

Although the foregoing has been described in some detail for purposes of clarity, it will be apparent that certain changes and modifications may be made without departing from the principles thereof. It should be noted that there are many alternative ways of implementing both the systems and methods described herein. Accordingly, the present embodiments are to be considered as illustrative and not restrictive, and the invention is not to be limited to the details given herein, but may be modified within the scope and equivalents of the appended claims.

What is claimed is:

1. A method performed by a local client device comprising a processor and a non-transitory computer-readable storage medium storing instructions that, when executed, cause the device to perform the method, the method comprising:
receiving a request from a remote system to transmit personal information relating to a user of the local client device to the remote system;
receiving an indication from the remote system that the remote system is authorized to receive at least a portion of the personal information;
determining, based on the indication, that the remote system is authorized to receive the at least a portion of the personal information;
generating filtered personal information based on the determination; and
transmitting the filtered personal information to the remote system.

2. The method of claim 1, wherein the indication from the remote system comprises a certified attribute.

3. The method of claim 2, wherein the certified attribute indicates that the user of the local client device is a user of the remote system.

4. The method of claim 1, wherein the filtered personal information comprises anonymized personal information.

5. The method of claim 1, wherein generating the filtered personal information comprises removing information that uniquely identifies the user of the local client device from the personal information.

6. The method of claim 1, wherein determining that the remote system is authorized to receive the at least a portion of the personal information further comprises evaluating one or more policies associated with the personal information to determine that the remote system is authorized to receive the at least a portion of the personal information.

7. The method of claim 6, wherein generating filtered personal information further comprises filtering the personal information based on the one or more policies.

8. The method of claim 6, wherein the one or more policies are securely associated with the personal information.

9. The method of claim 1, where personal information contained in a profile associated with the user of the local client device.

10. The method of claim 1, wherein the remote system comprises a peer client device.

11. The method of claim 1, wherein the remote system comprises a trusted clearinghouse.

12. The method of claim 1, wherein the personal information comprises at least one of certified attributes, usage data, user-volunteered personal information, shared user personal information, aggregated user personal information, and personally-identifiable information.
